(19) United States
(12) Patent Application Publication
(10) Pub. No.: US 2024/0169770 A1
(43) Pub. Date: May 23, 2024

(54) SERVER, MANAGEMENT METHOD, MANAGEMENT SYSTEM, AND DISPLAY DEVICE

(71) Applicant: TOYOTA JIDOSHA KABUSHIKI KAISHA, Toyota-shi (JP)

(72) Inventors: Mitsuaki TOMITA, Toyota-shi (JP); Hiroshi ASHIDA, Nukata-gun (JP); Kenji TAHARA, Toyota-shi (JP); Tamaki OZAWA, Toyota-shi (JP); Takenori SHIMIZU, Inuyama-shi (JP); Tetsuro KUNIYOSHI, Nagoya-shi (JP)

(73) Assignee: TOYOTA JIDOSHA KABUSHIKI KAISHA, Toyota-shi (JP)

(21) Appl. No.: 18/377,077

(22) Filed: Oct. 5, 2023

(30) Foreign Application Priority Data
Nov. 21, 2022 (JP) 2022-186009

(51) Int. Cl. G07C 5/00; B60L 3/12; G06Q 10/02; G06Q 10/20; G07C 5/08

(52) U.S. Cl. CPC G07C 5/008; B60L 3/12; G06Q 10/02; G06Q 10/20; G07C 5/0825

(57) ABSTRACT

A server includes a control unit configured to extract from a plurality of items of the maintenance check those item(s) that can be performed within a reservation period reserved by a user of an electrified vehicle for power control including either or both of charging and discharging of a battery of the electrified vehicle, based on a length of the reservation period. The server further includes a communication unit configured to send information on the extracted item(s) to at least one device out of the electrified vehicle and a first information device of the user.

### CROSS-REFERENCE TO RELATED APPLICATION

This application claims priority to Japanese Patent Application No. 2022-186009 filed on Nov. 21, 2022 incorporated herein by reference in its entirety.

### BACKGROUND

### 1. Technical Field

The present disclosure relates to servers, management methods, management systems, and display devices.

### 2. Description of Related Art

WO2013/137071 discloses a system that charges an electrified vehicle based on a reservation for use of a charger.

### SUMMARY

A user of an electrified vehicle may want to make good use of the charging time of the electrified vehicle. One possible way is to have a maintenance check on the electrified vehicle during charging of the electrified vehicle. It is therefore desired to appropriately perform a maintenance check on an electrified vehicle during charging (and discharging) of the electrified vehicle.

The present disclosure provides a server, a management method, a management system, and a display device that can appropriately perform a maintenance check on an electrified vehicle during either or both of charging and discharging of the electrified vehicle.

A server according to a first aspect of the present disclosure is configured to manage a maintenance check of an electrified vehicle. The server includes a control unit and a communication unit. The control unit is configured to extract from a plurality of items of the maintenance check at least one item that is able to be performed within a reservation period reserved by a user of the electrified vehicle for power control including either or both of charging and discharging of a battery of the electrified vehicle, based on a length of the reservation period. The communication unit is configured to send information on the at least one item to at least one device out of the electrified vehicle and a first information device of the user.

In the server according to the first aspect of the present disclosure, as described above, the information on the at least one item that is able to be performed within the reservation period is sent to the at least one device. This allows the user to select the item that is able to be performed within the reservation period. As a result, the maintenance check can be appropriately performed on the electrified vehicle during the power control of the electrified vehicle.

In the server according to the first aspect, the control unit may be configured to extract the at least one item that is able to be completed within the reservation period. With this configuration, the user can select a maintenance item that is sure to be completed within the reservation period.

In the server according to the first aspect, the control unit may be configured to extract the at least one item based on a length of time required for each of the plurality of items and a schedule of a worker who performs the maintenance check. With this configuration, any maintenance item that is difficult for the worker to take care of is less likely to be notified to the user.

In the server according to the first aspect, the at least one device may include a display unit. The control unit may be configured to perform control to send to the at least one device through the communication unit a signal for displaying the extracted at least one item and an item not extracted from the plurality of items in different modes from each other on the display unit. With these configurations, the user can acquire information on the extracted item and can also acquire information on the non-extracted item.

In the server according to the first aspect, the control unit may be configured to extract an item recommended to be performed out of the at least one item, based on information on a travel plan of the electrified vehicle. The control unit may be configured to perform control to send information on which of the at least one item is the recommended item to the at least one device through the communication unit. With these configurations, the user can acquire information on the item recommended based on the travel plan of the electrified vehicle out of the item(s) that is able to be performed within the reservation period.

In the server according to the first aspect, the control unit may be configured to extract an item recommended to be performed out of the at least one item, based on history information of the maintenance check of the electrified vehicle. The control unit may be configured to perform control to send information on which of the at least one item is the recommended item to the at least one device through the communication unit. With these configurations, the user can acquire information on the item recommended based on the history information of the maintenance check out of the item(s) that is able to be performed within the reservation period.

In the server configured to extract the at least one item that is able to be completed within the reservation period, the at least one device may include a display unit. The control unit may be configured to predict a scheduled completion time at which the power control is completed, and the control unit may be configured to, when the at least one item includes multiple items and the scheduled completion time is earlier than an end time of the reservation period, perform control to send to the at least one device through the communication unit a signal for displaying an item that is going to be completed by the scheduled completion time out of the multiple items and an item that is going to be completed after the scheduled completion time out of the multiple items in different modes from each other on the display unit. With these configurations, the item that is able to be completed by the scheduled completion time can be selected when the scheduled completion time of the power control is earlier than the end time of the reservation period. This allows the user to leave earlier with the electrified vehicle.

In the server according to the first aspect, the control unit may be configured to perform control to send information on an item selected by the user out of the at least one item to a second information device through the communication unit, the second information device being a device of a worker of a shop where the maintenance check is performed. With this configuration, the worker of the shop can smoothly start performing the maintenance item selected by the user.

A management method according to a second aspect of the present disclosure is a management method for managing a maintenance check of an electrified vehicle. The management method includes: extracting from a plurality of items of a maintenance check at least one item that is able to be performed within a reservation period reserved by a user of the electrified vehicle for power control including either or both of charging and discharging of a battery of the electrified vehicle, based on a length of the reservation period; and sending information on the at least one item to at least one device out of the electrified vehicle and a first information device of the user.

In the management method according to the second aspect of the present disclosure, as described above, the information on the at least one item that is able to be performed within the reservation period is sent to the at least one device. This allows the user to select the item that is able to be performed within the reservation period. As a result, the management method can be provided with which the maintenance check can be appropriately performed on the electrified vehicle during the power control of the electrified vehicle.

A management system according to a third aspect of the present disclosure includes: an electrified vehicle; and a server configured to manage a maintenance check of the electrified vehicle. The server is configured to extract from a plurality of items of the maintenance check at least one item that is able to be performed within a reservation period reserved by a user of the electrified vehicle for power control including either or both of charging and discharging of a battery of the electrified vehicle, based on a length of the reservation period. The server is configured to send information on the at least one item to at least one device out of the electrified vehicle and a first information device of the user.

In the management system according to the third aspect of the present disclosure, as described above, the information on the at least one item that is able to be performed within the reservation period is sent to the at least one device. This allows the user to select the item that is able to be performed within the reservation period. As a result, the management system can be provided with which the maintenance check can be appropriately performed on the electrified vehicle during the power control of the electrified vehicle.

In the management system according to the third aspect, the server may be configured to receive information on an item selected by the user out of the at least one item. The server may be configured to control the electrified vehicle based on the item selected by the user. With these configurations, the state of the electrified vehicle is controlled based on the item selected by the user, which makes it easier to perform the item.

A display device according to a fourth aspect of the present disclosure is mounted on at least one device out of an electrified vehicle and a first information device of a user of the electrified vehicle. The at least one device is configured to communicate with a server configured to extract from a plurality of items of a maintenance check of the electrified vehicle at least one item that is able to be performed within a reservation period reserved by the user of the electrified vehicle for power control including either or both of charging and discharging of a battery of the electrified vehicle, based on a length of the reservation period. The server is configured to send information on the at least one item to the at least one device. The display device includes: a signal acquisition unit configured to acquire a signal that is based on the information received by the at least one device; and a display unit configured to display the at least one item based on the signal acquired by the signal acquisition unit.

In the display device according to the fourth aspect of the present disclosure, as described above, the at least one item that is able to be performed within the reservation period is displayed on the display unit. As a result, the display device can be provided with which the maintenance check can be appropriately performed on the electrified vehicle during the power control of the electrified vehicle.

In the display device according to the fourth aspect, the display unit may be configured to display the at least one item extracted by the server and an item not extracted from the plurality of items by the server in different modes from each other. With this configuration, the display device can be provided that can acquire information on the extracted item and can also acquire information on the non-extracted item.

In the display device according to the fourth aspect, the server may be configured to extract an item recommended to be performed out of the at least one item, based on information on a travel plan of the electrified vehicle. The display unit may be configured to indicate which of the at least one item is the recommended item. With these configurations, the display device can be provided that can acquire information on the item recommended based on the travel plan of the electrified vehicle out of the item(s) that is able to be performed within the reservation period.

In the display device according to the fourth aspect, the server may be configured to extract an item recommended to be performed out of the at least one item, based on history information of the maintenance check of the electrified vehicle. The display unit may be configured to indicate which of the at least one item is the recommended item. With these configurations, the display device can be provided that can acquire information on the item recommended based on the history information of the maintenance check out of the item(s) that is able to be performed within the reservation period.

In the display device according to the fourth aspect, the server may be configured to predict a scheduled completion time at which the power control is completed. The display unit may be configured to, when the at least one item includes multiple items and the scheduled completion time is earlier than an end time of the reservation period, display an item that is going to be completed by the scheduled completion time out of the multiple items and an item that is going to be completed after the scheduled completion time out of the multiple items in different modes from each other. With these configurations, the display device can be provided that allows the item that is able to be completed by the scheduled completion time to be selected when the scheduled completion time of the power control is earlier than the end time of the reservation period.

According to the present disclosure, a maintenance check can be appropriately performed on an electrified vehicle during either or both of charging and discharging of the electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a management system according to an embodiment;

FIG. 2 shows the configuration of a navigation system;

FIG. 3 shows the configuration of mobile equipment;

FIG. 4 shows sequence control of the management system according to the embodiment;

FIG. 5 shows an initial reservation screen of an electric vehicle supply equipment (EVSE) unit according to the embodiment;

FIG. 6 shows a reservation screen of the EVSE unit after extraction of maintenance items according to the embodiment; and

FIG. 7 shows the relationship between charging and maintenance check according to the embodiment.

### DETAILED DESCRIPTION OF EMBODIMENTS

Hereinafter, an embodiment of the present disclosure will be described in detail with reference to the drawings. The same or corresponding parts are denoted by the same signs throughout the drawings, and description thereof will not be repeated.

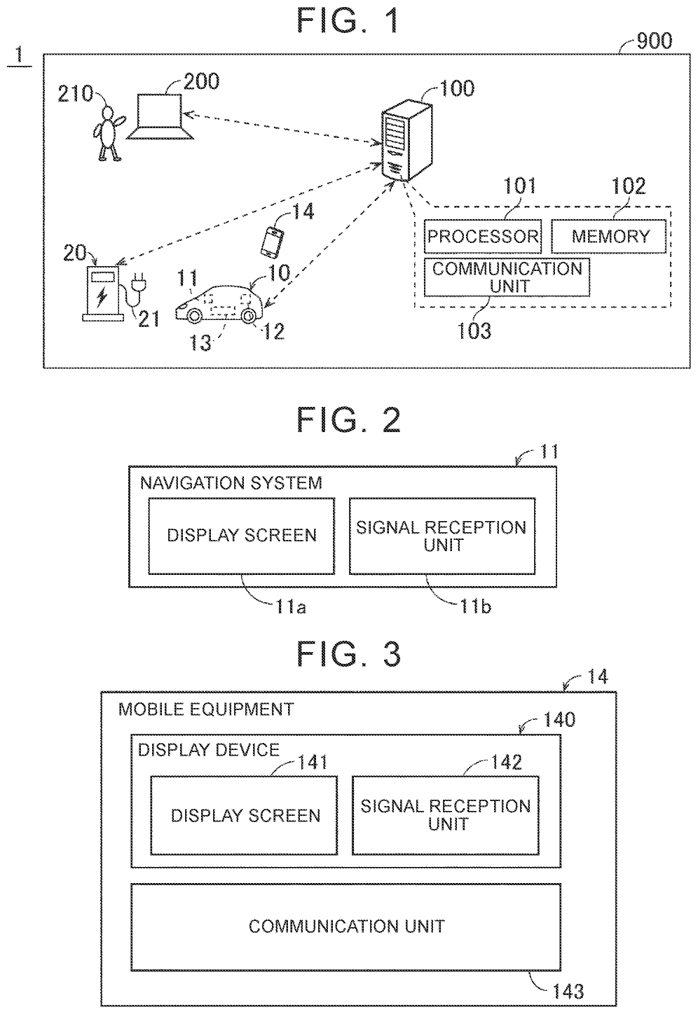

FIG. 1 shows the configuration of a management system 1 according to the embodiment. The management system 1 includes a server 100, equipment 200, an electrified vehicle 10, and an electric vehicle supply equipment (EVSE) unit 20. The electrified vehicle 10 is an example of the “at least one device” according to the present disclosure.

The server 100, the equipment 200, and the EVSE unit 20 are located at a dealership 900. The equipment 200 is equipment that is used by a worker 210 of the dealership 900. At the dealership 900, there may be a plurality of workers 210 available to perform a maintenance check that will be described later. The dealership 900 is an example of the “shop” according to the present disclosure.

Examples of the electrified vehicle 10 include a plug-in hybrid electric vehicle (PHEV), a battery electric vehicle (BEV), and a fuel cell electric vehicle (FCEV).

The electrified vehicle 10 includes a navigation system 11 and a communication device 12. The electrified vehicle 10 further includes a battery 13 that supplies power to electric devices such as the navigation system 11 and the communication device 12. The communication device 12 may include a Data Communication Module (DCM) or may include a communication interface (I/F) compatible with the fifth generation mobile communication system (5G). The navigation system 11 is an example of the “display device” according to the present disclosure.

The electrified vehicle 10 is configured to be electrically connected to the EVSE unit 20. The battery 13 of the electrified vehicle 10 is charged by connecting a charging cable 21 connected to the EVSE unit 20 to an inlet of the electrified vehicle 10. Charging of the battery 13 with the EVSE unit 20 is an example of the “power control” according to the present disclosure.

The server 100 is a server that manages a maintenance check of the electrified vehicle 10. The server 100 also manages charging reservations for the electrified vehicle 10 (and other electrified vehicles) with the EVSE unit 20. A server that manages a maintenance check of the electrified vehicle 10 and a server that manages a charging reservation for the electrified vehicle 10 may be separately provided.

The server 100 is configured to manage information on a plurality of registered electrified vehicles 10 (hereinafter also referred to as “vehicle information”), information on each registered user (hereinafter also referred to as “user information”), and information on each registered EVSE unit 20 (hereinafter also referred to as “EVSE information”). The user information, the vehicle information, and the EVSE information are distinguished by identification information (IDs) and stored in a memory 102 of the server 100 in association with the IDs.

A user ID is identification information identifying a user, and also serves as information identifying mobile equipment 14 carried by the user (equipment ID). The server 100 is configured to distinguish information received from pieces of mobile equipment 14 by the user IDs and save the information in association with the user IDs. The user information includes communication addresses of the pieces of mobile equipment 14 carried by the users, and vehicle IDs of the electrified vehicles 10 belonging to the users. The mobile equipment 14 is an example of the “first information device.”

The vehicle ID is identification information identifying an electrified vehicle 10. The vehicle ID may be a license plate number or may be a vehicle identification number (VIN). The vehicle information includes an action plan of each electrified vehicle 10.

An EVSE-ID is identification information identifying an EVSE unit 20. The EVSE information includes communication addresses of the EVSE units 20 and the state of the electrified vehicles 10 connected to the EVSE units 20. The EVSE information also includes information indicating combinations of the electrified vehicle 10 and the EVSE unit 20 connected to each other (e.g., combinations of the EVSE-ID and the vehicle ID).

The server 100 includes a processor 101, the memory 102, and a communication unit 103. The processor 101 is an example of the “control unit” according to the present disclosure.

The memory 102 stores, in addition to programs to be executed by the processor 101, information to be used in the programs (e.g., maps, mathematical formulas, and various parameters). The memory 102 also stores schedule information of the worker 210. The schedule information is updated as the schedule of the worker 210 is changed.

The memory 102 also stores information on each of a plurality of items of a maintenance check of the electrified vehicle 10. Specifically, the memory 102 stores information on the time required for each of the items. For example, the memory 102 stores information that checking tire pressures takes 30 minutes and replacing an air conditioning filter takes 60 minutes. The memory 102 also stores information on the cost for each of the items.

The communication unit 103 includes various communication interfaces (I/Fs). The processor 101 controls the communication unit 103. Specifically, the processor 101 communicates with each of the communication device 12 of the electrified vehicle 10 (or mobile equipment 14), the EVSE unit 20, and the equipment 200 via the communication unit 103.

As shown in FIG. 2, the navigation system 11 includes a display screen 11a and a signal reception unit 11b. The display screen 11a displays an image that is based on a signal received by the signal reception unit 11b. The signal reception unit 11b receives (acquires) a signal that is based on a signal received by the electrified vehicle 10 (communication device 12) from the server 100. The signal that is based on the signal received from the server 100 may be the signal received by the communication device 12 from the server 100, or may be a signal obtained by conversion of the signal received by the communication device 12 from the server 100 by a predetermined processing unit. The display screen 11a and the signal reception unit 11b are an example of the “display unit” and the “signal acquisition unit” according to the present disclosure, respectively.

As shown in FIG. 3, the mobile equipment 14 includes a display device 140 including a display screen 141 and a signal reception unit 142. The mobile equipment 14 further includes a communication unit 143. The display screen 141 displays an image that is based on a signal received by the signal reception unit 142. The signal reception unit 142 receives (acquires) a signal that is based on a signal received by the communication unit 143 from the server 100. The signal that is based on the signal received from the server 100 may be the signal received by the communication unit 143 from the server 100, or may be a signal obtained by conversion of the signal received by the communication unit 143 from the server 100 a predetermined processing unit.

The user of the electrified vehicle 10 may want to make good use of the charging time of the electrified vehicle 10. One possible way is to have a maintenance check on the electrified vehicle 10 during charging of the electrified vehicle 10. It is therefore desired to appropriately perform a maintenance check on the electrified vehicle 10 during charging of the electrified vehicle 10.

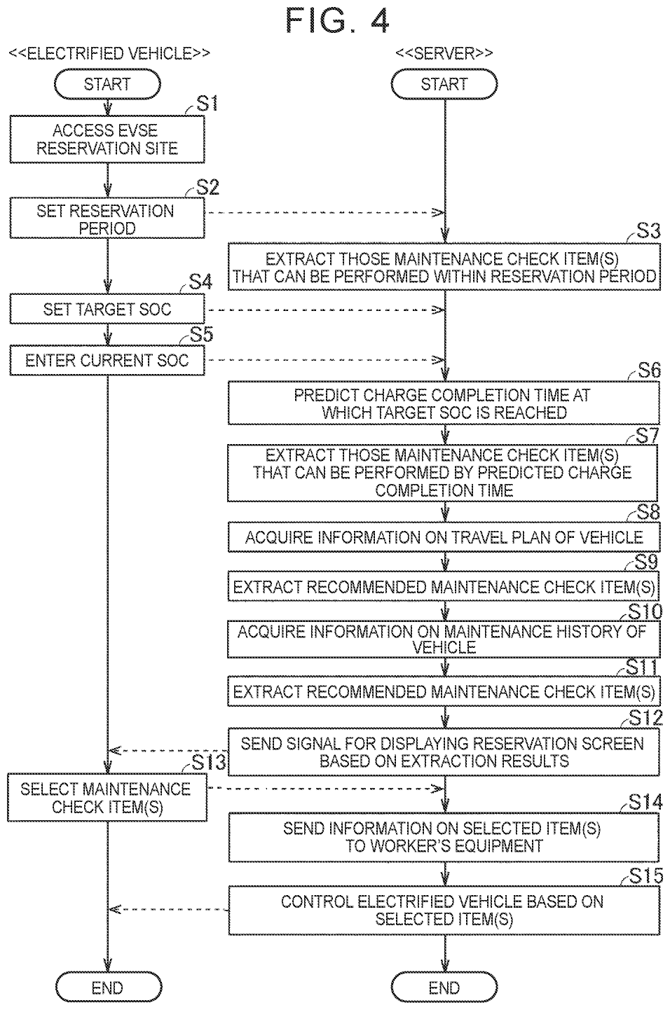

In the present embodiment, the processor 101 extracts from the plurality of items of the maintenance check those item(s) that can be performed (can be completed) within a reservation period reserved by the user for charging the battery 13 of the electrified vehicle 10, based on the length of the reservation period. The processor 101 then sends information on the extracted item(s) to the electrified vehicle 10 (communication device 12) through the communication unit 103. In other words, the processor 101 sends to the electrified vehicle 10 through the communication unit 103 a signal for causing the electrified vehicle 10 to notify the extracted item(s). That is, the processor 101 sends to the electrified vehicle 10 (communication device 12) through the communication unit 103 a signal for controlling the electrified vehicle 10 (navigation system 11) to notify the user of the extracted item(s). This will be described in detail with reference to the sequence diagram of FIG. 4.

Management Method

A method for managing a maintenance check of the electrified vehicle 10 by the management system 1 will be described with reference to the sequence diagram of FIG. 4.

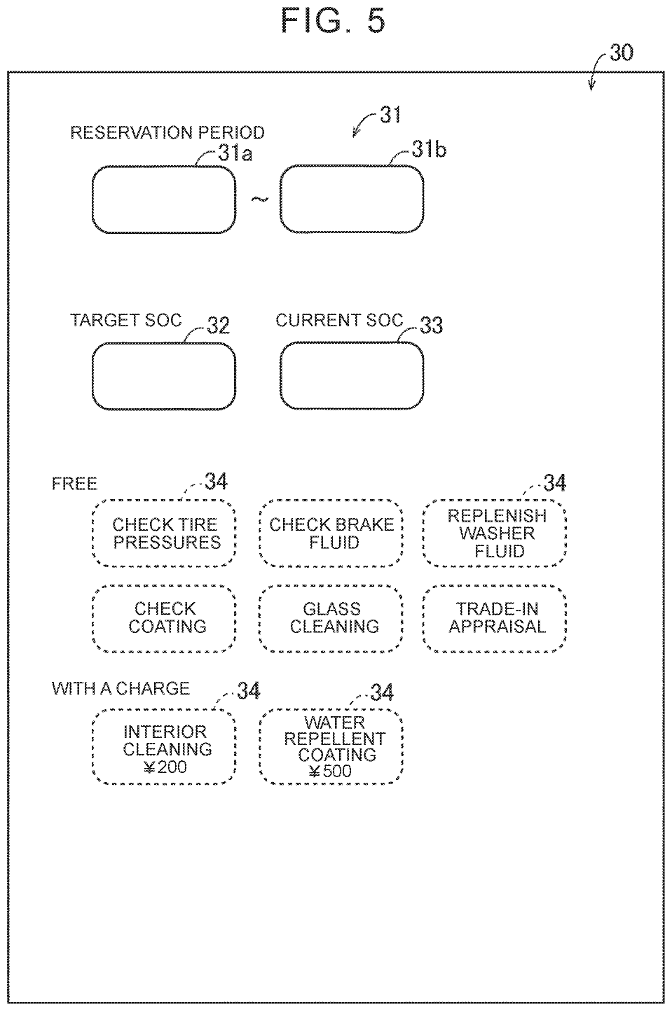

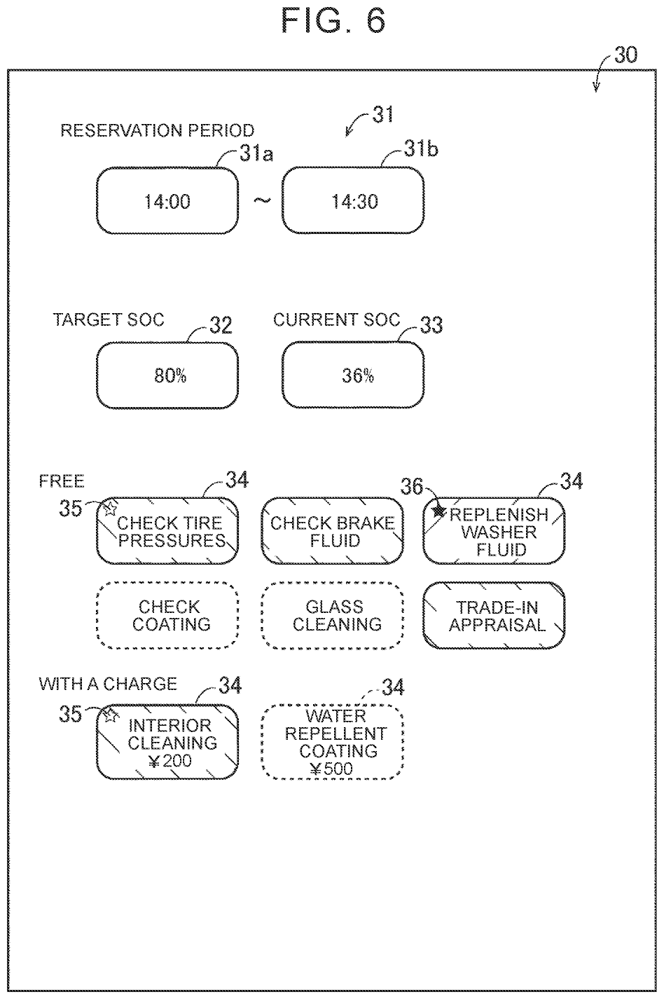

In step S1, the user of the electrified vehicle 10 accesses through the navigation system 11 a reservation site for making a reservation to use the EVSE unit 20. A reservation screen 30 (see FIG. 5) for the EVSE unit 20 is thus displayed on the navigation system 11. The reservation site may be accessed through the mobile equipment 14, and the reservation screen 30 may be displayed on the mobile equipment 14. As shown in FIG. 5, the reservation screen 30 displays free items and items with a charge such that they are distinguished from each other. The configuration of the reservation screen 30 is not limited to the examples of FIG. 5 and FIG. 6 described later.

The reservation screen 30 displays the plurality of items of the maintenance check that can be taken care of at the dealership 900. A select operation on the plurality of items displayed on the reservation screen 30 is not accepted in step S1. For example, in step S1, select buttons 34 corresponding to each item are displayed in gray (shown by dashed lines in FIG. 5).

The free items include “check tire pressures,” “check brake fluid,” “replenish washer fluid,” “check coating,” “glass cleaning,” and “trade-in appraisal.” The items with a charge include “interior cleaning” and “water repellent coating.”

In step S2, the user of the electrified vehicle 10 enters in an input field 31 on the reservation screen 30 a reservation period the user is going to reserve for charging the battery 13. The input field 31 includes a field 31a for entering the start time of the reservation period and a field 31b for entering the end time of the reservation period.

In step S3, the processor 101 extracts those item(s) that can be performed within the reservation period set by the user in step S2 from the plurality of items of the maintenance check, based on the length of the reservation period. For example, in the case where the user sets a reservation period from 14:00 to 14:30 in step S2, those item(s) that can be completed within 30 minutes are extracted from the plurality of items.

The processor 101 extracts those item(s) that can be completed within the reservation period and for which the worker 210 is available during the reservation period. Therefore, those items for which no worker 210 is available during the reservation period (because the workers are working on other tasks) will not be extracted.

In step S4, the user of the electrified vehicle 10 enters in an input field 32 on the reservation screen 30 a target value of the state of charge (SOC) of the battery 13 that is to be increased by charging. In the case where no numerical value is entered in the input field 32, the target value may be automatically set to 100%.

In step S5, the user of the electrified vehicle 10 enters the current SOC of the battery 13 in an input field 33 on the reservation screen 30. In the case where no numerical value is entered in the input field 33, the current SOC may be automatically set to a predetermined value (e.g., 30%). Alternatively, information on the current SOC may be acquired by the server 100 (communication unit 103). Alternatively, the processor 101 may estimate the current SOC based on the travel history etc. of the electrified vehicle 10.

In step S6, the processor 101 estimates (calculates) the time required for the SOC of the electrified vehicle 10 to reach the target value of the SOC set in step S4. Specifically, the processor 101 estimates the time based on the difference between the target value and the current SOC entered (acquired) in step S5. For example, the processor 101 estimates the time by dividing the electric energy corresponding to the difference by the charging energy per unit time. The processor 101 thus predicts the charge completion time at which charging of the electrified vehicle 10 is completed.

In step S7, the processor 101 extracts those item(s) that can be performed (can be completed) by the charge completion time predicted in step S6 from the plurality of items of the maintenance check. For example, in the case where the reservation period is 14:00 to 14:30 and the time required for the SOC of the electrified vehicle 10 to reach the target SOC as estimated in step S6 is 20 minutes, those item(s) that can be performed (can be completed) by 14:20 are extracted. Step S7 is not performed when the time required for the SOC of the electrified vehicle 10 to reach the target SOC as estimated in step S6 is longer than the length of the reservation period set in step S2. The predicted charge completion time is an example of the “scheduled completion time” according to the present disclosure.

The processor 101 extracts those item(s) for which the worker 210 is available between the charge start time and the charge completion time. Therefore, those item(s) for which no worker 210 is available between the charge start time and the charge completion time (because the workers are working on other tasks) will not be extracted. Steps S4 to S7 may be performed before step S2.

In step S8, the server 100 (communication unit 103) acquires information on a travel plan of the electrified vehicle 10. The information on the travel plan includes, for example, information on a travel route of the electrified vehicle 10 after completion of charging and a destination of the electrified vehicle 10 after completion of charging. The information on the travel plan may be sent from the electrified vehicle 10 or from a server, not shown, that manages information on the electrified vehicle 10, etc. to the server 100.

In step S9, the processor 101 extracts those item(s) recommended for the electrified vehicle 10 from the plurality of items of the maintenance check, based on the information acquired in step S8. For example, in the case where the electrified vehicle 10 is going to travel on a highway after charging, those item(s) that require attention when traveling at high speed (e.g., “check tire pressures”) may be extracted.

In step S10, the server 100 (communication unit 103) acquires history information of the maintenance check indicating the history of any past maintenance checks performed on the electrified vehicle 10. The history information includes any maintenance check items performed on the electrified vehicle 10 in the past and inspection dates corresponding to these items. The history information may be sent from the electrified vehicle 10 or form the server, not shown, that manages information on the electrified vehicle 10, etc. to the server 100.

In step S11, the processor 101 extracts those item(s) recommended for the electrified vehicle 10 from the plurality of items of the maintenance check, based on the information acquired in step S10. For example, those item(s) that have not been performed for the last predetermined period of time (e.g., six months) or more may be extracted.

For example, steps S8 to S11 may be performed in step S1.

In step S12, the processor 101 sends to the electrified vehicle 10 information on the extraction results in each of steps S3, S7, S9, and S11. Specifically, the processor 101 sends to the communication device 12 of the electrified vehicle 10 a signal for displaying the reservation screen 30 that is based on the extraction results.

The signal reception unit 11b of the navigation system 11 receives a signal that is based on a signal received by the communication device 12. Therefore, the reservation screen 30 updated based on the extraction results is displayed on the display screen 11a of the navigation system 11.

The signal for displaying the reservation screen 30 that is based on the extraction results may be sent to the communication unit 143 of the mobile equipment 14. In this case, the display screen 141 and the signal reception unit 142 are an example of the “display unit” and the “signal acquisition unit” according to the present disclosure, respectively. In this case, the mobile equipment 14 is an example of the “at least one device” according to the present disclosure. The signal for displaying the reservation screen 30 that is based on the extraction results may be sent to both the electrified vehicle 10 (communication device 12) and the mobile equipment 14.

Specifically, the processor 101 sends to the electrified vehicle 10 (communication device 12) through the communication unit 103 a signal for displaying the item(s) extracted in step S3 and the item(s) not extracted in step S3 in different modes from each other. More specifically, the processor 101 changes the color of the select button(s) 34 corresponding to the item(s) extracted in step S3 from gray to green (represented by lines slanting downward to the right in FIG. 6). The select button(s) 34 corresponding to the item(s) extracted in step S3 are changed to a selectable state on the reservation screen 30. The processor 101 keeps the color of the select button(s) 34 corresponding to the item(s) not extracted in step S3 gray. The method for distinguishing between the item(s) extracted in step S3 and the item(s) not extracted in step S3 is not limited to that described in the above example.

The processor 101 sends to the electrified vehicle 10 (communication device 12) through the communication unit 103 a signal for displaying the item(s) extracted in step S7 and the item(s) not extracted in step S7 out of the items extracted in step S3 in different modes from each other on the reservation screen 30. In other words, the processor 101 performs a process of displaying the item(s) that can be performed (can be completed) by the predicted charge completion time and the item(s) that can be performed (can be completed) after the charge completion time within the reservation period in different modes from each other.

Specifically, the processor 101 performs a process of displaying in green the select button(s) 34 corresponding to the item(s) that can be performed (can be completed) after the charge completion time within the reservation period. The processor 101 also performs a process of displaying in orange (represented by line slanting upward to the right in FIG. 6) the select button(s) 34 corresponding to the item(s) that can be performed (can be completed) by the charge completion time. The method for distinguishing between the item(s) that can be performed (can be completed) after the charge completion time within the reservation period and the item(s) that can be performed (can be completed) by the charge completion time is not limited to the above example.

The processor 101 also performs a process of adding, for example, a white star mark 35 (see FIG. 6) on the select button(s) 34 corresponding to the item(s) extracted based on the information on the travel plan of the electrified vehicle 10 (information of S8) out of the item(s) extracted in step S3 or S7. The user is thus notified of which item(s) are the item(s) extracted based on the information on the travel plan of the electrified vehicle 10. The color, shape, and position of the mark 35 are not limited to those in the above example. The user may be notified of the item(s) extracted based on the information on the travel plan by a method other than adding the mark 35 (e.g., by sending a notification message to the user).

The processor 101 also performs a process of adding, for example, a black star mark 36 (see FIG. 6) on the select button(s) 34 corresponding to the item(s) extracted based on the history information of the maintenance check of the electrified vehicle 10 (information of S10) out of the item(s) extracted in step S3 or S7. The user is thus notified of which item(s) are the item(s) extracted based on the history information of the maintenance check of the electrified vehicle 10. The color, shape, and position of the mark 36 are not limited to those in the above example. The user may be notified of the item(s) extracted based on the history information of the maintenance check by a method other than adding the mark 36 (e.g., by sending a notification message to the user).

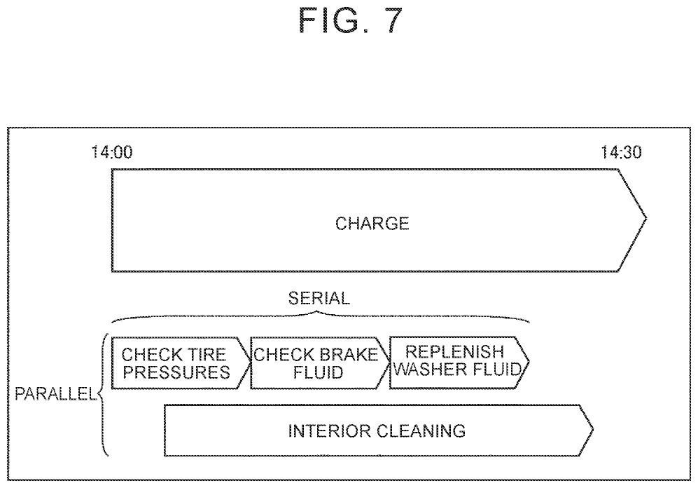

In step S13, the user selects a desired maintenance check item on the reservation screen 30 updated by step S12. The user can select multiple items. In the case where the multiple items selected by the user cannot be performed in parallel and are going to be performed in series (see FIG. 7), the processor 101 adjusts the reservation screen 30 so that the total time required for the selected multiple items becomes equal to or less than the length of the reservation period.

For example, it is assumed that the reservation period is 30 minutes and the user first selected the item that requires 10 minutes to complete. In this case, the processor 101 adjusts the reservation screen 30 so that the user can only select from those items that require 20 minutes (30 minutes minus 10 minutes) or less to complete. Specifically, the processor 101 changes those select buttons 34 corresponding to the items that require 20 minutes or more to a non-selectable state. Those item(s) that can be performed in parallel with the first selected item that requires 10 minutes to complete (see FIG. 7) can be selected if their required time(s) are 30 minutes or less. Item selection may be performed after charging is started.

In step S14, the processor 101 sends information on the item(s) selected in step S13 to the equipment 200 of the worker 210. Specifically, the processor 101 sends to the equipment 200 through the communication unit 103 a signal for notifying the item(s) selected in step S13. The item(s) selected in step S13 are thus notified to the worker 210 through the equipment 200. The equipment 200 is an example of the “second information device.”

In step S15, the processor 101 controls the electrified vehicle 10 based on the item(s) selected in step S13. For example, the processor 101 unlocks the doors of the electrified vehicle 10 when any item that requires the worker 210 to get into the vehicle (e.g., “interior cleaning”) is selected in step S13. The processor 101 may perform control such as disconnecting communication between the electrified vehicle 10 and the mobile equipment 14 or lowering the volume of a music player of the navigation system 11. The processor 101 may also control an electronically controlled suspension when “check tire pressures” is selected by the user. Step 15 may be performed simultaneously with step S14.

As described above, in the present embodiment, the processor 101 extracts those item(s) that can be performed within the reservation period reserved for charging the battery 13 of the electrified vehicle 10 from the plurality of items of the maintenance check, based on the length of the reservation period. The communication unit 103 then notifies the user of the extracted item(s). This can reduce the possibility that the user may select a maintenance check item that is difficult to complete within the reservation period.

The above embodiment illustrates an example in which a reservation for charging the electrified vehicle 10 is made. However, the present disclosure is not limited to this. For example, a reservation for discharging may be reserved in response to a virtual power plant (VPP) or energy management request. In this case, the discharging is an example of the “power control” according to the present disclosure. Both charging and discharging may be performed.

The above embodiment illustrates an example in which those item(s) that can be completed within the reservation period are extracted. However, the present disclosure is not limited to this. For example, an item that cannot be completed by the end time of the reservation period may be extracted as long as at least part of the work is performed within the reservation period.

The above embodiment illustrates an example in which the item(s) extracted by the processor 101 and the item(s) not extracted by the processor 101 are displayed in different modes from each other. However, the present disclosure is not limited to this. The item(s) not extracted by the processor 101 may not be displayed.

The above embodiment illustrates an example in which the item(s) extracted by the server 100 are displayed on the navigation system 11. However, the present disclosure is not limited to this. The item(s) extracted by the server 100 may be notified to the user by voice.

The above embodiment illustrates an example in which the EVSE unit 20 is installed at the dealership 900. However, the present disclosure is not limited to this. The EVSE unit 20 may be installed at a parking lot etc. In this case, a worker of the dealership 900 may be dispatched to the EVSE unit 20 to perform a maintenance check.

The above embodiment illustrates an example in which the items of the maintenance check are items that are manually performed by the worker 210. However, the present disclosure is not limited to this. For example, the items of the maintenance check may include a process of updating a vehicle program by Over-The-Air (OTA) technology.

The above embodiment illustrates an example in which extraction based on the target SOC (extraction in step S7), extraction based on the travel plan (extraction in step S9), and extraction based on the maintenance history (extraction in step S11) are performed in addition to extraction of the item(s) that can be performed based on the length of the reservation period. However, the present disclosure is not limited to this. The extraction in step S7, the extraction in step S9, and the extraction in step S11 may not be performed. Alternatively, only one of the extraction in step S7, the extraction in step S9, and the extraction in step S11 may be performed. Alternatively, only two of the extraction in step S7, the extraction in step S9, and the extraction in step S11 may be performed.

The above embodiment illustrates an example in which the items are extracted based on the length of time required for each of the plurality of items of the maintenance check and the schedule of the worker 210. However, the present disclosure is not limited to this. The extraction may be performed based on the length of time required for each of the plurality of items, regardless of the schedule of the worker 210.

The above embodiment illustrates an example in which those item(s) that can be completed by the charge completion time at which charging of the battery 13 is completed and those item(s) that can be completed after the charge completion time within the reservation period are displayed in different modes from each other. However, the present disclosure is not limited to this. For example, those item(s) that can be completed after the charge completion time may not be displayed and those item(s) that can be completed by the charge completion time may be displayed.

The embodiment disclosed herein should be considered to be illustrative in all respects and not restrictive. The scope of the present disclosure is shown by the claims rather than by the above description of the embodiment, and is intended to include all modifications within the meaning and scope equivalent to the claims.

What is claimed is:

1. A server configured to manage a maintenance check of an electrified vehicle, the server comprising:
a control unit configured to extract from a plurality of items of the maintenance check at least one item that is able to be performed within a reservation period reserved by a user of the electrified vehicle for power control including either or both of charging and discharging of a battery of the electrified vehicle, based on a length of the reservation period; and
a communication unit configured to send information on the at least one item to at least one device out of the electrified vehicle and a first information device of the user.

2. The server according to claim 1, wherein the control unit is configured to extract the at least one item that is able to be completed within the reservation period.

3. The server according to claim 1, wherein the control unit is configured to extract the at least one item based on a length of time required for each of the plurality of items and a schedule of a worker who performs the maintenance check.

4. The server according to claim 1, wherein:
the at least one device includes a display unit; and
the control unit is configured to perform control to send to the at least one device through the communication unit a signal for displaying the extracted at least one item and an item not extracted from the plurality of items in different modes from each other on the display unit.

5. The server according to claim 1, wherein:
the control unit is configured to extract an item recommended to be performed out of the at least one item, based on information on a travel plan of the electrified vehicle; and
the control unit is configured to perform control to send information on which of the at least one item is the recommended item to the at least one device through the communication unit.

6. The server according to claim 1, wherein:
the control unit is configured to extract an item recommended to be performed out of the at least one item, based on history information of the maintenance check of the electrified vehicle; and
the control unit is configured to perform control to send information on which of the at least one item is the recommended item to the at least one device through the communication unit.

7. The server according to claim 2, wherein:
the at least one device includes a display unit;
the control unit is configured to predict a scheduled completion time at which the power control is completed; and
the control unit is configured to, when the at least one item includes multiple items and the scheduled completion time is earlier than an end time of the reservation period, perform control to send to the at least one device through the communication unit a signal for displaying an item that is going to be completed by the scheduled completion time out of the multiple items and an item that is going to be completed after the scheduled completion time out of the multiple items in different modes from each other on the display unit.

8. The server according to claim 1, wherein the control unit is configured to perform control to send information on an item selected by the user out of the at least one item to a second information device through the communication unit, the second information device being a device of a worker of a shop where the maintenance check is performed.

9. A management method for managing the maintenance check of the electrified vehicle using the server according to claim 1, the management method comprising:
extracting from the plurality of items of the maintenance check the at least one item that is able to be performed within the reservation period reserved by the user of the electrified vehicle for the power control including either or both of charging and discharging of the battery of the electrified vehicle, based on the length of the reservation period; and
sending the information on the at least one item to the at least one device out of the electrified vehicle and the first information device of the user.

10. A management system comprising:
an electrified vehicle; and
a server configured to manage a maintenance check of the electrified vehicle, wherein
the server is configured to extract from a plurality of items of the maintenance check at least one item that is able to be performed within a reservation period reserved by a user of the electrified vehicle for power control including either or both of charging and discharging of the electrified vehicle, based on a length of the reservation period, and
the server is configured to send information on the at least one item to at least one device out of the electrified vehicle and a first information device of the user.

11. The management system according to claim 10, wherein:
the server is configured to receive information on an item selected by the user out of the at least one item; and
the server is configured to control the electrified vehicle based on the item selected by the user.

12. A display device mounted on at least one device out of an electrified vehicle and a first information device of a user of the electrified vehicle, the at least one device being configured to communicate with a server configured to extract from a plurality of items of a maintenance check of the electrified vehicle at least one item that is able to be performed within a reservation period reserved by the user of the electrified vehicle for power control including either or both of charging and discharging of a battery of the electrified vehicle, based on a length of the reservation period, and the server being configured to send information on the at least one item to the at least one device,
the display device comprising:
a signal acquisition unit configured to acquire a signal that is based on the information received by the at least one device; and
a display unit configured to display the at least one item based on the signal acquired by the signal acquisition unit.

13. The display device according to claim 12, wherein the display unit is configured to display the at least one item extracted by the server and an item not extracted from the plurality of items by the server in different modes from each other.

14. The display device according to claim 12, wherein:
the server is configured to extract an item recommended to be performed out of the at least one item, based on information on a travel plan of the electrified vehicle; and
the display unit is configured to indicate which of the at least one item is the recommended item.

15. The display device according to claim 12, wherein:
the server is configured to extract an item recommended to be performed out of the at least one item, based on history information of the maintenance check of the electrified vehicle; and
the display unit is configured to indicate which of the at least one item is the recommended item.

16. The display device according to claim 12, wherein:
the server is configured to predict a scheduled completion time at which the power control is completed; and
the display unit is configured to, when the at least one item includes multiple items and the scheduled completion time is earlier than an end time of the reservation period, display an item that is going to be completed by the scheduled completion time out of the multiple items and an item that is going to be completed after the scheduled completion time out of the multiple items in different modes from each other.
